(19) United States
(12) Patent Application Publication
(10) Pub. No.: US 2014/0109653 A1
(43) Pub. Date: Apr. 24, 2014

(54) INTELLIGENT PIPELINE PRESSURE SENSING DEVICE

(71) Applicant: Ching-Chih Chan, Taichung City (TW)

(72) Inventor: Ching-Chih Chan, Taichung City (TW)

(73) Assignee: TAIWAN LORD ELECTRON CO.,LTD., Taichung City (TW)

(21) Appl. No.: 14/058,234

(22) Filed: Oct. 19, 2013

(30) Foreign Application Priority Data
Oct. 19, 2012 (TW) 101138758

(51) Int. Cl. G01N 15/08

(52) U.S. Cl. CPC G01N 15/082
USPC 73/38

(57) ABSTRACT

An intelligent pipeline pressure sensing device is disclosed. Conventionally, both blower and exhaust fan use the motor with fixed rotation speed to drive the fan blade, so the input/output airflow and pressure are also fixed. When the air inlet duct and air outlet duct are longer or have angle, or the filter is clogged, the drag in the air inlet and outlet ducts increases to cause the airflow or pressure therein to drop, which leads to inefficiency of the equipment and energy usage. The present invention is advantageous because the extent of clogging of the filter can be automatically detected and the user will be notified to wash or replace the filter, so the equipment can be operated at its best condition and in an energy-saving manner.

### FIELD OF THE INVENTION

The present invention relates to an intelligent pipeline pressure sensing device, and more particularly to a sensing device that can display the extent of clogging in a filter and tell the user to wash or replace the filter, so the equipment can be operated at its best condition.

### BACKGROUND OF THE INVENTION

Most conventional pipelines for blowers and exhaust fans are shown in FIG. 3, which usually have a gas inlet duct (60) and a gas outlet duct (61) connected together. A fan blade (631) driven by a motor (63) is disposed between the gas inlet duct (60) and the gas outlet duct (61). A filter (602) is disposed on a gas inlet (601) of the gas inlet duct (60), and when the fan blade (631) is driven by the motor (63), the air can be sucked from the gas inlet (601) and exhausted from a gas outlet (611) of the gas outlet duct (61).

Because both the blower and exhaust fan use the motor (63) with fixed rotation speed to drive the fan blade (631), so the input/output airflow and pressure are also fixed. When the gas inlet duct (60) and gas outlet duct (61) are longer or have angle, or the filter (602) is clogged, the drag in the air duct increases to cause the airflow or pressure therein to drop, which leads to inefficiency of the equipment and energy usage.

To solve the problem presented above, one conventional method is to improve the rotation speed of the motor (63) from fixed to changeable. So when the drag in the air duct increases, the rotation speed of the motor (63) increases as well to maintain the airflow and pressure. However, an airflow sensor or a pressure sensor (64) has to be installed (as shown in FIG. 4) to send the detected signal to a control device (65) to change the rotation speed of the motor (63) to achieve the close-loop control.

Another method is to set an electrical current level according to the airflow and motor current. When the airflow decreases because of drag, the current is lower than the set electrical current level to increase the rotation speed of the motor, so the motor current can be brought up to the set level to maintain the airflow.

However, the abovementioned two methods focus on the airflow that decreases because of drag, but these methods cannot detect the clogging of the filter. Furthermore, these methods do not provide waning to the users to wash or replace the filter to maintain the pumping/exhaust fans at its peak level.

### SUMMARY OF THE INVENTION

As discussed above, two conventional methods to solve the reduced airflow focus on the drag, but these methods cannot detect the clogging of the filter. Furthermore, these methods do not provide waning to the users to wash or replace the filter to maintain the pumping/exhaust fans at its peak level.

The present invention provides an intelligent pipeline pressure sensing device having a controller that is electrically connected to a fan motor, and includes a setting unit, a comparing unit and a rotation speed sensing unit. The rotation speed sensing unit of the controller is used to determine whether a filter is clogged according to the airflow and rotation speed, wherein the fan motor is used to drive a fan in an air guiding duct to rotate, and the fan motor has a driving unit and a motor coil unit. The motor coil unit can be electrically connected to a control unit through the driving unit, or directly connected to the control unit, and the driving unit is used to drive the motor coil unit. The control unit is configured to control the operation status of the motor coil unit; and the filter is disposed at an air inlet of the air guiding duct.

The present invention is advantageous because the because the extent of clogging of the filter can be automatically detected and the user will be notified to wash or replace the filter, so the equipment can be operated at its best condition and in an energy-saving manner.

### BRIEF DESCRIPTION OF THE DRAWINGS

FIG. 1 illustrates a structure of the present invention.

FIG. 2 illustrates a chart including time/rotation speed in the present invention.

FIG. 3 illustrates a conventional airflow pipeline.

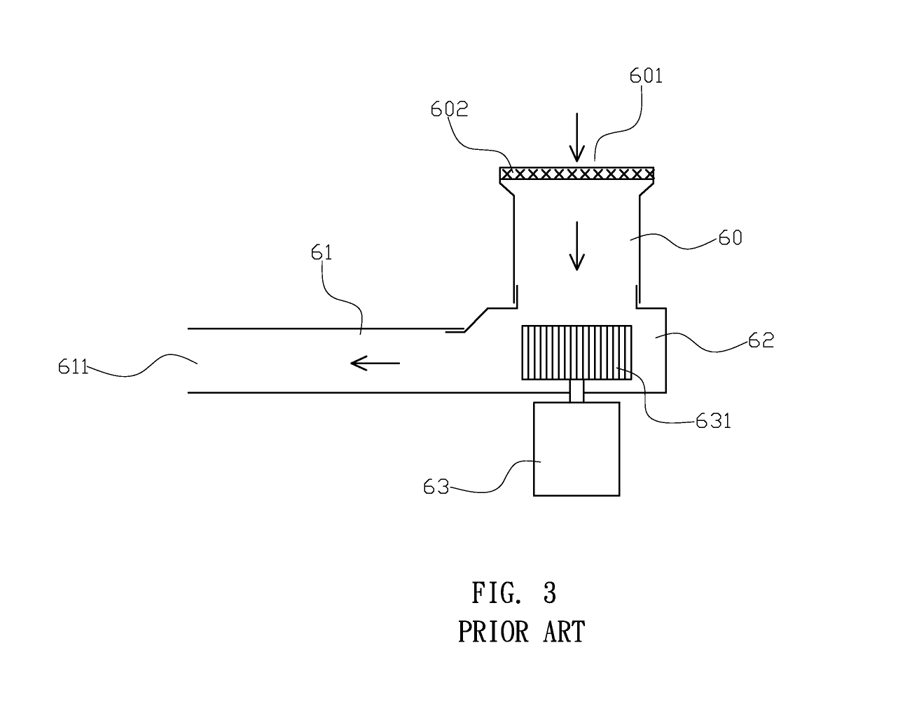

FIG. 4 illustrates another conventional airflow pipeline.

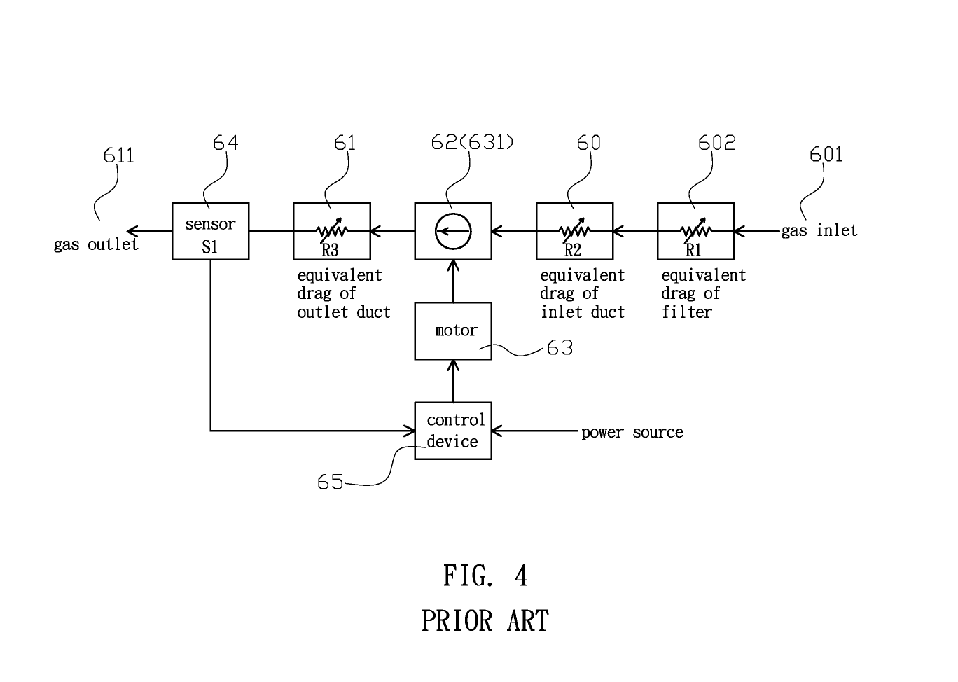

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

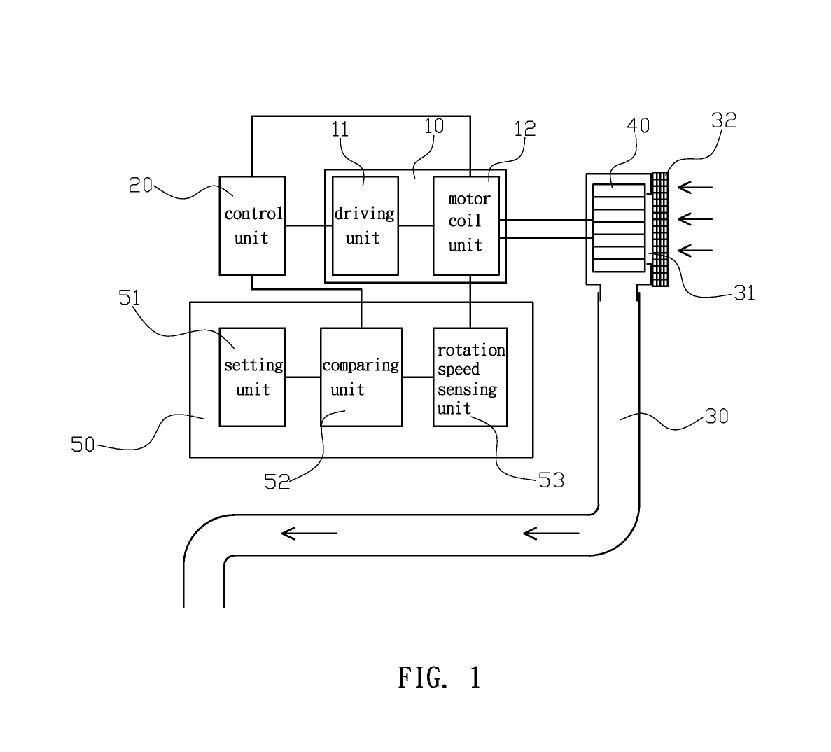

Referring to FIG. 1, a sensing device may have a controller (50) that is electrically connected to a fan motor (10), and includes a setting unit (51), a comparing unit (52) and a rotation speed sensing unit (53). The rotation speed sensing unit (53) of the controller (50) is used to determine whether a filter (32) is clogged according to the airflow and rotation speed, wherein the fan motor (10) is used to drive a fan (40) in an air guiding duct (30) to rotate, and the fan motor (10) has a driving unit (11) and a motor coil unit (12). The motor coil unit (12) can be electrically connected to a control unit (20) through the driving unit (11), or directly connected to the control unit (20), and the driving unit (11) is used to drive the motor coil unit (12). The control unit (20) is configured to control the operation status of the motor coil unit (12); and the filter (32) is disposed at an air inlet (31) of the air guiding duct (30).

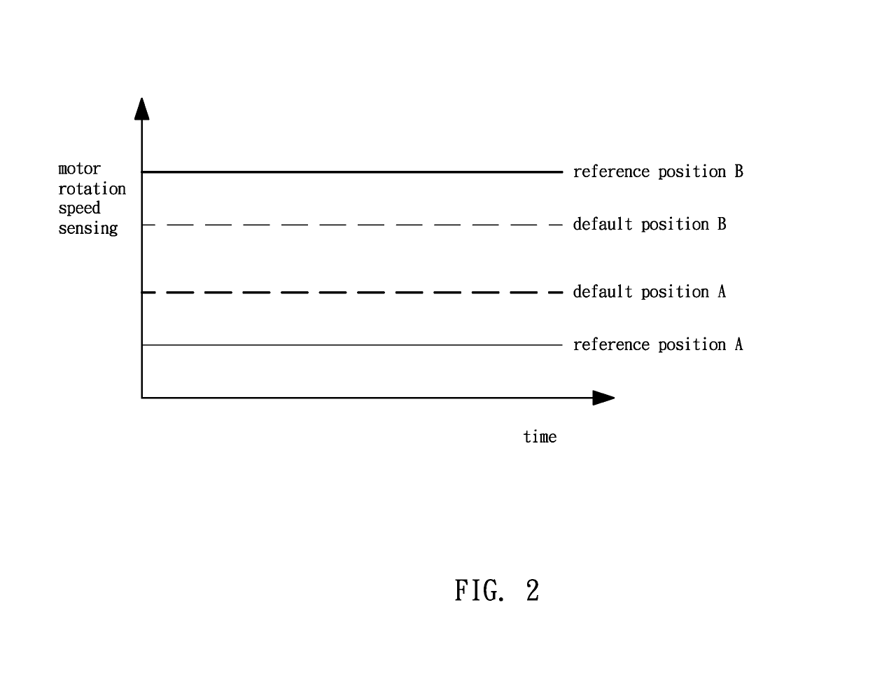

According to the structure discussed above, the present invention is an exhaust/pumping fan in a free-flow field with an airflow whose rotation speed is set as reference A (clogging rate for filer 32 is 0%, see FIG. 2), and rotation speed when the air inlet (31) and the filter (32) are completely clogged (clogging rate for filter 32 is 100%) is set as reference B. Also, there are default position A and default position B. When the exhaust/pumping fan needs a longer air guiding duct (30) or the air guiding duct (30) has an angle, an air duct drag is created to reduce the airflow. In the mean time, the fan motor (10) will increase the rotation speed to compensate the airflow as shown in default position A. in addition, the default position indicates whether the fan motor is well installed.

Furthermore, space between the default position A and reference position B indicates the clogging rate 0˜100% after the filter (32) is installed. When the filter (32) is clogging, the fan motor (10) increases the rotation speed to compensate the airflow, and when the rotation speed reaches reference position B and is detected by the rotation speed sensing unit (53), the controller (50) sends out a warning signal to tell the user to wash or replace the filter (32).

Also, a display unit can be attached to the controller (50) to show the extent of clogging of the filter (32) or airflow. The intelligent sensing device can also be used in vacuums, dust collecting devices, air conditions that have fan structure used to pump/exhaust airflow.

According to the embodiments described above, the present invention is advantageous because the extent of clogging of the filter (32) can be automatically detected and the user will be notified to wash or replace the filter (32), so the equipment can be operated at its best condition and in an energy-saving manner.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An intelligent pipeline pressure sensing device comprising a controller that is electrically connected to a fan motor to drive fan blades in an air duct; and
a setting unit, a comparing unit and a rotation speed sensing unit, wherein the rotation speed sensing unit of the controller is used to determine whether a filter is clogged according to airflow and rotation speed of the fan motor.

2. The intelligent pipeline pressure sensing device of claim 1, wherein the fan motor has a driving unit and a motor coil unit.

3. The intelligent pipeline pressure sensing device of claim 2, wherein the motor coil unit is electrically connected to a control unit through the driving unit.

4. The intelligent pipeline pressure sensing device of claim 2, wherein the motor coil unit is directly connected to the control unit.

5. The intelligent pipeline pressure sensing device of claim 1, wherein a display unit is attached to the controller to display extent of clogging of the filter.

6. The intelligent pipeline pressure sensing device of claim 1, wherein a display unit is attached to the controller to display extent of airflow.

7. The intelligent pipeline pressure sensing device of claim 1, wherein the sensing device is configured to use in vacuums, dust collecting devices, air conditions that have fan structure used to pump/exhaust airflow.
